(19) United States
(12) Patent Application Publication
(10) Pub. No.: US 2017/0344001 A1
(43) Pub. Date: Nov. 30, 2017

(54) PORTABLE DEVICE

(71) Applicant: DENSO CORPORATION, Kariya-city (JP)

(72) Inventor: Yasuhiko MUKAI, Kariya-city (JP)

(21) Appl. No.: 15/604,101

(22) Filed: May 24, 2017

(30) Foreign Application Priority Data
May 26, 2016 (JP) 2016-104829

(51) Int. Cl. G05D 1/00; G08C 17/02; G05D 1/02

(52) U.S. Cl. CPC G05D 1/0016; G05D 1/0212; G08C 17/02

(57) ABSTRACT

A portable device is applied to a vehicle having an automatic parking function of allowing the vehicle to run and park automatically in a predetermined position in a state where a user is out of the vehicle. The portable device includes a forward button member which is operated by the user when moving the vehicle forward, and a backward button member which is operated by the user when moving the vehicle backward. The portable device further includes a signal output unit having a function of outputting an automatic parking instruction signal for setting the vehicle in an automatic parking mode by touch-operating both the forward and backward button members. In this configuration, the forward button member has a forward arrow light emitting portion, and the backward button member has a backward arrow light emitting portion.

### CROSS-REFERENCE TO RELATED APPLICATION

This application is based on and claims the benefit of priority from earlier Japanese Patent Application No. 2016-104829 filed May 26, 2016, the description of which is incorporated herein by reference.

### TECHNICAL FIELD

The present disclosure relates to a portable device applied to a vehicle having an automatic parking function.

### BACKGROUND

Conventionally, as disclosed in Japanese Patent Application Laid-Open Publication No. 2015-96422, for example, a parking assistance system having a function of supporting a parking operation of a user in a state where the user is in a vehicle while parking the vehicle has been known.

More specifically, in this system, tracks to be followed by the vehicle to a planned parking position are displayed on a display unit provided in a vehicle cabin.

The user parks the vehicle at a predetermined position by steering the vehicle while watching the display.

As a parking assistance system, there is also a system applied to a vehicle having an automatic parking function of allowing a vehicle to run and park automatically in a predetermined position in a state where a user is out of the vehicle.

In this system, the user pushes a predetermined button provided in a portable device such as a vehicle key device to park the vehicle in the predetermined position.

However, since the user remotely operates the portable device outside the vehicle, there is concern that the operability of the portable device may be deteriorated in a situation where surroundings of the user are dark such as nighttime in this system.

### SUMMARY

An embodiment provides a portable device capable of improving operability in a situation where surroundings of a user are dark.

An aspect of a portable device which is applied to a vehicle having an automatic parking function allowing the vehicle to run and park automatically in a predetermined position in a state where a user is out of the vehicle, and which is operated in a state of being carried by the user, the portable device including a first operating section which is operated by the user when moving the vehicle forward, and a second operating section which is operated by the user when moving the vehicle backward.

The portable device further includes a signal output unit that outputs a move-forward instruction signal for moving the vehicle forward in a period during which the first operating section is operated, and a move-backward instruction signal for moving the vehicle backward in a period during which the second operating section is operated

Each of the operating sections has a light emitting portion that emits light.

As a remote control function of automatic parking, it is conceivable to provide a portable device with a function of instructing a vehicle to move forward and another function of instructing the vehicle to move backward.

In view of the above, the disclosure is provided with the first operating section which is operated by the user when moving the vehicle forward and the second operating section which is operated by the user when moving the vehicle backward.

Here, from a viewpoint of safety, a configuration is conceivable to prevent the vehicle from moving forward or backward unless the operating sections are continuously operated.

In view of the above, the above disclosure is provided with the signal output unit that outputs the move-forward instruction signal for moving the vehicle forward in a period during which the first operating section is operated, and the move-backward instruction signal for moving the vehicle backward in a period during which the second operating section is operated.

Further, from the viewpoint of safety, in the case of automatically driving the vehicle by remote control, it is considered preferable to press the operating sections to move the vehicle forward and backward while the user visually checks a situation of the vehicle in a state where the user has got out of the vehicle.

However, in this case, in a situation where surroundings of the user are dark, such as at night, a position of an operating section that is desired to be operated becomes difficult to find.

In this case, an operability of the portable device may be deteriorated.

In this regard, in the above disclosure, the first and second operating sections have light emitting portions that emit light.

Therefore, even in a situation where the surroundings of the user are dark, it is possible to make it easy to find the positions of the operating sections that the user desires to touch-operate.

Thereby, operability of the portable device can be improved.

### BRIEF DESCRIPTION OF THE DRAWINGS

In the accompanying drawings:

FIG. 1 shows an overall configuration diagram of a vehicle system according to a first embodiment;

FIG. 2 shows a front view of a portable device;

FIG. 3 shows a state transition diagram of an operation mode of a vehicle;

FIG. 4 shows an overall configuration diagram of a vehicle system according to a second embodiment;

FIG. 5 shows a flow chart of a process procedure of a vehicle-side control unit; and

FIG. 6 shows a flowchart of the processing procedure of a portable-side control unit.

### DETAILED DESCRIPTION OF THE PREFERRED EMBODIMENT

### First Embodiment

Hereinafter, a first embodiment of a portable device according to the present disclosure will be described with reference to the drawings.

The portable device constitutes a parking assistance system used with a vehicle.

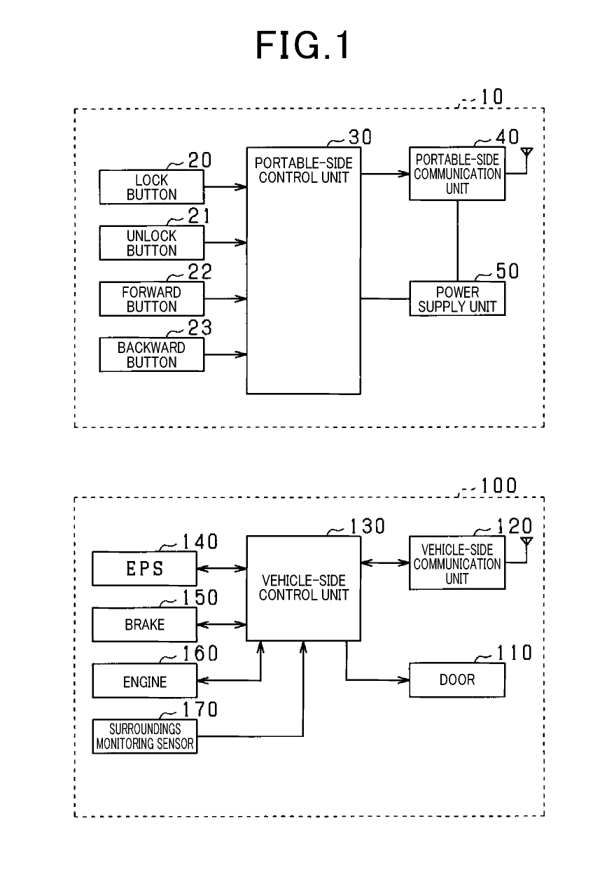

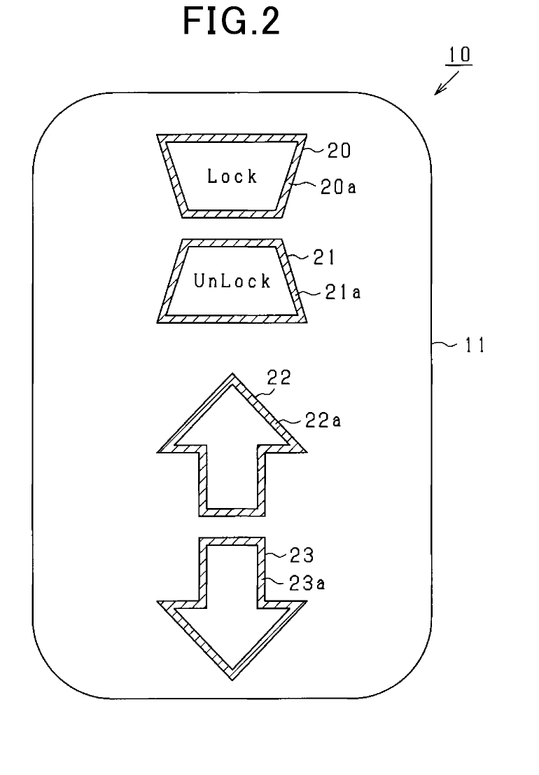

First, a portable device 10 will be described with reference to FIGS. 1 and 2.

The portable device 10 includes a main body portion 11, a lock button member 20, an unlock button member 21, a forward button member 22 as a first operating section, and a backward button member 23 as a second operating section.

The main body portion 11 has a flat shape having a substantially rectangular front surface part.

The lock button member 20, the unlock button member 21, the forward button member 22, and the backward button member 23 are disposed in this order aligned in a longitudinal direction of the main body portion 11.

Each of these members 20 to 23 is disposed so as to be exposed on the front surface part of the main body portion 11.

The main body portion 11 and each of the members 20 to 23 are made of synthetic resin, for example.

As shown in FIG. 2, each of the members 20 to 23 has a configuration symmetrical in the longitudinal direction of the main body portion 11 with the lock button member 20 and the unlock button member 21 as a pair, and the forward button member 22 and the backward button member 23 as another pair.

Specifically, the lock button member 20 and the unlock button member 21 are each formed in a symmetrical shape having a trapezoidal shape.

In addition, the forward button member 22 and the backward button member 23 are each formed in a symmetrical arrow shape.

When defining one end side in the longitudinal direction of the main body part 11 as a front end side and another end side as a rear end side, the lock button member 20 and the unlock button member 21 are disposed on the front end side of the main body portion 11, and the forward button member 22 and the backward button member 23 are disposed on the rear end side of the main body portion 11.

The portable device 10 further includes a portable-side control unit 30, the portable-side communication unit 40, and a power supply unit 50 that supplies power to the portable-side control unit 30, which is a signal output unit, and the portable-side communication unit 40.

The portable-side control unit 30 and the portable-side communication unit 40 are operable by electric power supplied from the power supply unit 50.

A storage battery can be used as the power supply unit 50, for example.

The portable-side control unit 30, the portable-side communication unit 40, and the power supply unit 50 are accommodated in an accommodation space of the main body unit 11.

It should be noted that the portable-side communication unit 40 is preferably disposed on the front end side of the main unit 11.

The lock button member 20 is a member that is pressed (i.e., operated) by a user to instruct the portable-side control unit 30 to generate a lock signal that instructs locking of doors 110 of the vehicle 100.

When the lock button member 20 is pressed, the portable-side control unit 30 generates the lock signal and outputs it to the portable-side communication unit 40.

On the other hand, the unlock button member 21 is a member that is pressed by the user to instruct the portable-side control unit 30 to generate an unlock signal that instructs to unlock the doors 110.

When the unlock button member 21 is pressed, the portable-side control unit 30 generates the unlock signal and outputs it to the portable-side communication unit 40.

In the present embodiment, the portable-side control unit 30 corresponds to a signal generation unit.

The forward button member 22 is a member that is pressed by the user to instruct the portable-side control unit to generate a move-forward instruction signal that instructs the vehicle 100 to move forward.

The portable-side control unit 30 continues to output the move-forward instruction signal to the portable-side communication unit 40 during a period when the forward button member 22 is pressed.

The backward button member 23 is a member that is pressed by the user to instruct the portable-side control unit 30 to generate a move-backward instruction signal that instructs the vehicle 100 to move backward.

The portable-side control unit 30 continues to output the move-backward instruction signal to the portable-side communication unit 40 during a period when the backward button member 23 is pressed.

The portable-side communication unit 40 has a function of wirelessly transmitting a signal generated by the portable-side control unit 30 to the vehicle 100.

Next, the vehicle 100 will be described.

The vehicle 100 includes a vehicle-side communication unit 120 and a vehicle-side control unit 130.

The vehicle-side communication unit 120 has a function of receiving a signal transmitted from the portable-side communication unit 40 and a function of wirelessly transmitting a signal generated by the vehicle-side control unit 130.

It should be noted that, in fact, although the vehicle 100 is provided with individual control units corresponding to various controls, a feature that the control units are individually provided is not a main feature in the present embodiment.

Therefore, in the present embodiment, these control units are shown as a single vehicle-side control unit 130 for convenience.

The vehicle 100 includes an electric power steering system (EPS) 140 and a braking system 150.

The electric power steering system 140 includes a steering motor that applies a steering force to a steering assembly (both are not shown).

The braking system 150 includes a brake actuator for adjusting hydraulic pressure of a master cylinder (both are not shown).

The vehicle 100 includes an engine 160 serving as a driving power source and a surroundings monitoring sensor 170.

The surroundings monitoring sensor 170 has a function of monitoring obstacles around the vehicle 100, and at least one of a sonar that detects objects using ultrasonic waves as transmission waves, a millimeter wave sensor, a laser sensor, and an imaging device may be included, for example.

The vehicle-side control unit 130 unlocks the doors 110 by sending the unlock signal received by the vehicle-side communication unit 120, or locks the doors 110 by inputting the lock signal received by the vehicle-side communication unit 120 to perform remote door locking.

The vehicle-side control unit 130 performs various controls of the vehicle 100.

Specifically, during a steering operation of the driver, the vehicle-side control unit 130 executes a power steering control that generates an assist force when changing a steering angle of a steering wheel by the electric power steering system 140.

In addition, the vehicle-side control unit 130 performs an automatic steering control for automatically controlling the steering angle by the electric power steering system 140 without a steering operation by the user.

The vehicle-side control unit 130 performs ABS control, traction control, and the like by the braking system 150 when the vehicle 100 is travelling.

In addition, the vehicle-side control unit 130 performs automatic braking control for automatically applying the braking force to the wheels by the braking system 150 without a braking operation by the user.

After the user holding the portable device 10 gets out of the vehicle 100, the vehicle-side control unit 130 receives instructions from the portable device 10 and performs an automatic parking control that parks the vehicle 100 to the parking space without the steering operation, an accelerator operation, and the brake operation by the user.

The automatic parking control is performed after stopping the vehicle 100 in front of the parking space, turning off the engine 160, and the user getting off the vehicle 100.

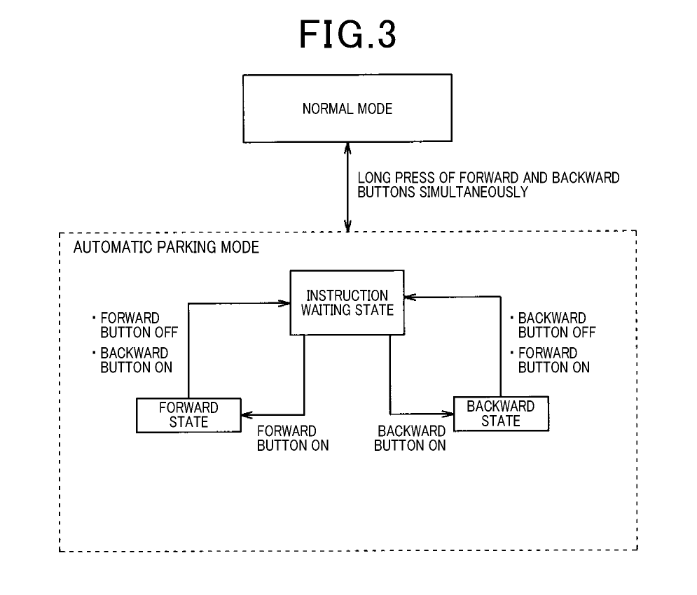

The automatic parking control will be described with reference to the state transition diagram of FIG. 3.

When both the forward button member 22 and the backward button member 23 are continuously pressed by the user for a predetermined time (2 seconds, for example), the portable-side control unit 30 generates an automatic parking instruction signal.

The automatic parking instruction signal is a signal that instructs to shift an operation mode of the vehicle 100 from a normal mode to an automatic parking mode.

The automatic parking instruction signal generated by the portable-side control unit 30 is inputted to the vehicle-side control unit 130 via the portable-side communication unit 40 and the vehicle-side communication unit 120.

The vehicle-side control unit 130 shifts the operation mode of the vehicle 100 from the normal mode to the automatic parking mode by the input of the automatic parking instruction signal, and then starts the engine 160.

According to a configuration in which the automatic parking instruction signal is generated by continuously pressing both forward and backward button members 22, 23, it is possible to reduce the number of button members compared with a configuration having a dedicated button member instructing generation of the automatic parking instruction signal.

Thereby, the configuration of the portable device 10 can be simplified.

The automatic parking mode includes an instruction waiting state, a forward state and a backward state.

When neither the move-forward instruction signal nor the move-backward instruction signal is received, that is, when neither the forward button member 22 nor the backward button member 23 is pressed, the vehicle-side control unit 130 selects the instruction waiting state.

The vehicle-side control unit 130 selects the forward state over a period during which the move-forward instruction signal is inputted, and selects the backward state over a period during which the move-backward instruction signal is inputted.

When the current state is the forward state, and when the move-forward instruction signal is not being received or when the move-backward instruction signal is being received, the vehicle-side control unit 130 switches a state from the forward state to the instruction waiting state.

On the other hand, when the current state is the backward state, and when the move-backward instruction signal is not being received or the move-forward instruction signal is being received, the vehicle-side control unit 130 switches state from the backward state to the instruction waiting state.

Note that when the current state is the forward state, the vehicle-side control unit 130 may switch state from the forward state to the instruction waiting state when a distance between the vehicle 100 and an obstacle in a forward direction is equal to or less than a predetermined distance.

Moreover, when the current state is the backward state, the vehicle-side control unit 130 may switch state from the backward state to the instruction waiting state when a distance between the vehicle 100 and an obstacle in a backward direction is equal to or less than a predetermined distance.

When selecting the instruction waiting state, the vehicle-side control unit 130 prohibits forward and backward movement of the vehicle 100 and stops the vehicle 100 at the current position.

When the forward state is selected, the vehicle-side control unit 130 moves the vehicle 100 forward while using the automatic steering control by the electric power steering system 140, under the automatic braking control by the braking system 150, and combustion control of the engine 160.

At this time, under the control of the vehicle-side control unit 130, based on monitoring results of obstacles by the surroundings monitoring sensor 170, the vehicle 100 may move forward while avoiding obstacles around the vehicle.

When the backward state is selected, the vehicle-side control unit 130 moves the vehicle 100 backward under automatic steering control, using the automatic braking control, and combustion control of the engine 160.

Even at this time, under the control of the vehicle-side control unit 130 based on monitoring results of obstacles by the surroundings monitoring sensor 170, the vehicle 100 may move backward while avoiding the obstacles around the vehicle.

In a case where the operation mode of the vehicle is set to the automatic parking mode, the portable-side control unit 30 transmits a release instruction signal when both the forward button member 22 and the backward button member 23 are continuously pressed by the user for a predetermined time period.

The release instruction signal is a signal instructing to shift the operation mode of the vehicle 100 from the automatic parking mode to the normal mode.

The release instruction signal generated by the portable-side control unit 30 is inputted to the vehicle-side control unit 130 via the portable-side communication unit 40 and the vehicle-side communication unit 120.

Upon an input of the release instruction signal, the vehicle-side control unit 130 shifts the operation mode of the vehicle 100 from the automatic parking mode to the normal mode, and stops the engine 160.

Next, the portable device 10 will be further described with reference to FIG. 2.

In the present embodiment, a configuration is adopted in which the forward button member 22 and the backward button member 23 emit light in a dark place.

Specifically, a portion where a luminous material is applied along a peripheral edge portion of the forward button member 22 is configured as a forward arrow light emitting portion 22a.

Further, a portion where the luminous material is applied along a peripheral edge portion of the backward button member 23 is configured as a backward arrow light emitting portion 23a.

In FIG. 2, each of the light emitting portions 22a, 23a is shown by hatching.

Note that a portion where the luminous material is applied along a peripheral edge portion of the lock button member 20 is configured as a lock light emitting portion 20a in the present embodiment.

In addition, a portion where the luminous material is applied along a peripheral edge portion of the unlock button member 21 is configured as an unlock light emitting portion 21a.

Shapes of the lock light emitting portion 20a and the unlock light emitting portion 21a are different from the shapes of the forward arrow light emitting portion 22a and the backward arrow light emitting portion 23a.

In the present embodiment, from the viewpoint of safety, it is configured that unless the forward and backward button members 22, 23 are kept depressed, the forward and reverse instruction signals are not outputted from the portable device 10 to the vehicle 100.

Further, from the viewpoint of safety, in the case of automatically driving the vehicle 100 by operating the portable device 10, it is considered preferable to press the button members 22, 23 to move the vehicle 100 forward and backward while the user visually checks a situation of the vehicle 100 in a state where the user is outside the vehicle 100.

However, in this case, in a situation where surroundings of the user are dark, such as at night, a position of a button member that is desired to be pressed becomes difficult to find.

Particularly in the present embodiment, since the main body portion 11 has a shape that is line symmetrical with respect to an axis thereof, it is difficult to confirm the positions of the forward and backward button members 22, 23 from the shape of the main body portion 11.

In this case, it is difficult to long-press the forward button member 22 and the backward button member 23 at the same time, and there is a possibility that the vehicle 100 cannot be shifted from the normal mode to the automatic parking mode.

In addition, despite desiring to move the vehicle 100 backward by pressing the backward button member 23 to park the vehicle 100 in the parking space, there is also a risk of erroneously pressing the forward button member 22.

In this way, the operability of the portable device 10 may be deteriorated in a situation where the surroundings of the user are dark.

Therefore, the forward button member 22 has the forward arrow light emitting portion 22a and the backward button member 23 has the backward arrow light emitting portion 23a in the present embodiment.

Thereby, the operability of the portable device 10 is improved as described below.

The user stops the vehicle 100 in front of the parking space.

Here, the vehicle 100 is stopped directing a front part of the vehicle 100 to the parking space.

Thereafter, the user turns off the engine 160. Then, the user has got out of the vehicle 100 with the portable device 10 and closes the doors 110 of the vehicle 100.

Here, even if the surroundings of the user are dark, the forward arrow light emitting portion 22a of the forward button member 22 emits light and the backward arrow light emitting portion 23a of the backward button member 23 emits light.

Therefore, the user can confirm where the forward and backward button members 22, 23 are located in the main body portion 11.

Therefore, the user can press both forward and backward button members 22, 23.

Particularly in the present embodiment, the shapes of the lock light emitting portion 20a and the unlock light emitting portion 21a disposed side by side with the forward arrow light emitting portion 22a and the backward arrow light emitting portion 23a are different from the shapes of the forward arrow light emitting portion 22a and the backward arrow light emitting portion 23a.

Therefore, by the user confirming in advance the positions of the forward button member 22 and the backward button member 23 with reference to the positions of the lock light emitting portion 20a and the unlock light emitting portion 21a in the main body unit 11, the forward and the backward button members 22, 23 can be easily identified.

As a result, the forward button member 22 and the backward button member 23 can be prevented from being erroneous operated.

When both forward and backward button members 22, 23 are pressed, the operation mode of the vehicle 100 is switched from the normal mode to the automatic parking mode.

Thereafter, the vehicle 100 moves forward for a period during which the user continues to press the forward button member 22.

When the user visually confirms that the vehicle 100 has reached the predetermined parking position, the pressing of the forward button member 22 is stopped.

Thereby, the vehicle 100 can be parked in a predetermined position.

Note that after that, by continuing pressing both forward and backward button members 22, 23, the automatic parking mode is switched to the normal mode.

As a result, the engine 160 is stopped. According to the present embodiment described above, the following effects can be obtained.

The forward and backward arrow light emitting portions 22a, 23a may be formed by applying a luminous material to the forward and backward button members 22, 23.

Therefore, it is possible to cause each of the light emitting portions 22a, 23a to emit light without consuming the power of the power supply unit 50.

Thereby, it becomes possible to confirm the positions of the forward and backward button members 22, 23 in a situation where the surroundings of the user are dark while reducing a replacement frequency and a charging frequency of the power supply unit 50.

As a result, the operability of the portable device 10 can be improved.

The shape of the forward button member 22 and the shape of the backward button member 23 are made different.

Further, the forward arrow light emitting portion 22a is formed along the peripheral edge portion of the forward button member 22, and the backward arrow light emitting portion 23a is formed along the peripheral edge portion of the backward button member 23.

According to this configuration, it is possible to use the portable device 10 even in a dark place with the same familiarity as in a bright place.

Thus, the forward button member 22 and the backward button member 23 can be prevented from being operated erroneously in a dark place.

### Second Embodiment

Hereinafter, a second embodiment will be described with reference to the drawings mainly on differences from the first embodiment.

In the present embodiment, a configuration of a light emitting portion is changed.

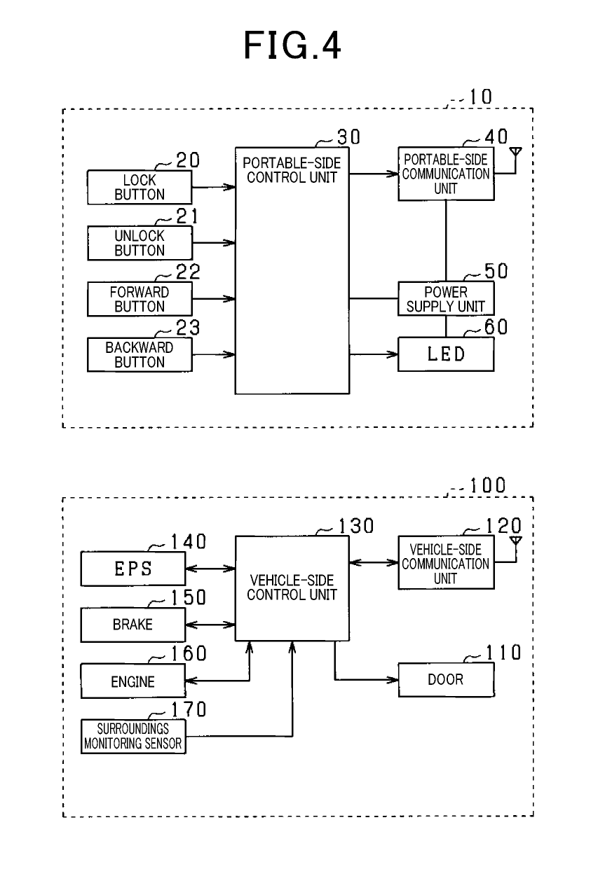

FIG. 4 shows an overall configuration diagram of the parking assistance system according to the present embodiment.

It should be noted that in FIG. 4, for the sake of convenience, the same reference numerals are given to the same components as those shown in FIG. 1.

As shown in FIG. 4, a portable device 10 includes a light source unit 60.

In the present embodiment, an LED is used as the light source unit 60.

The light source unit 60 emits light when electric power is supplied from the power supply unit 50.

A light emission control of the light source unit 60 is performed by a portable-side control unit 30 as a light emission control unit.

In the present embodiment, a portable-side communication unit 40 has a function of receiving a signal wirelessly transmitted from a vehicle-side communication unit 120 and outputting the signal to the portable-side control unit 30.

Next, a light emitting portion provided in each button member according to the present embodiment will be described.

Note that since the shape of each light emitting portion according to the present embodiment is similar to that in FIG. 2, it will be described with reference to FIG. 2.

In the present embodiment, in the forward button member 22, its peripheral portion is formed of a material having optical transparency, and the remaining portion is formed of a material having no optical transparency.

A portion formed of the material having optical transparency in the forward button member 22 serves as a forward arrow light emitting portion 22a.

In the backward button member 23, its peripheral portion is formed of a material having optical transparency, and the remaining portion is formed of a material having no optical transparency.

A portion formed of the material having optical transparency in the backward button member 23 serves as a backward arrow light emitting portion 23a.

Incidentally, the material having optical transparency is, for example, a transparent synthetic resin, and the material having no optical transparency is, for example, a black synthetic resin.

In the present embodiment, the light source unit 60 is provided in a portion that faces the forward arrow light emitting portion 22a and the backward arrow light emitting portion 23a in a housing space of the main body portion 11.

By the light emission control of the portable-side control unit 30, the light of the light source unit 60 is irradiated from the back of the forward arrow light emitting portion 22a and the backward arrow light emitting portion 23a.

As a result, the irradiated light passes through the forward arrow light emitting portion 22a and the backward arrow light emitting portion 23a, and the forward arrow light emitting portion 22a and the backward arrow light emitting portion 23a emit light.

In the present embodiment, the light source unit 60 emits light on condition that the user has got out of the vehicle and the user is present within a predetermined range from the vehicle 100.

For this reason, the portable-side control unit 30 and the vehicle-side control unit 130 perform predetermined processing while exchanging information with each other.

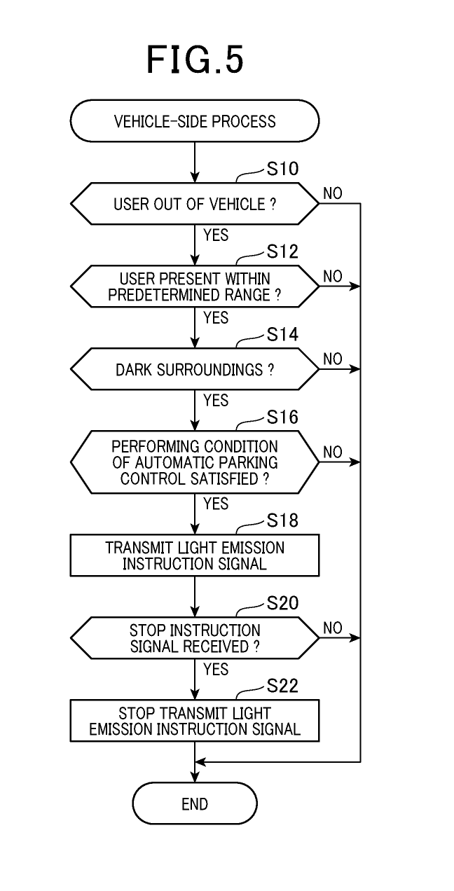

First, FIG. 5 shows a procedure of a process executed by the vehicle-side control unit 130.

This process is repeatedly executed at predetermined intervals, for example.

In this series of processing, first in step S10, it is determined whether or not the user has got out of the vehicle.

Here, for example, it may be determined based on a signal transmitted from the portable device 10 that it is determined that the user has got out of the vehicle by determining that the portable device 10 is not in a vehicle cabin detection area.

If it is determined in step S10 that the user has gotten off the vehicle, the process proceeds to step S12, and it is determined whether or not the user is present within a predetermined range from the vehicle 100.

This process is a process for determining whether or not the user is present near the vehicle 100.

Here, for example, based on the signal transmitted from the portable device 10, it may be determined that the user is present within the predetermined range when it is determined that the portable device 10 is present in an external detection area near the vehicle 100.

If an affirmative determination is made in step S12, the process proceeds to step S14, and it is determined whether or not the surroundings of the vehicle 100 are dark.

Here, for example, it may be determined whether or not it is dark based on a detection value of an illuminance sensor provided in the vehicle 100.

If an affirmative determination is made in step S14, the process proceeds to step S16, and it is determined whether or not an autopark condition of the automatic parking control is satisfied.

The autopark is for determining that the situation of the vehicle 100 and its surroundings are not a dangerous situation in performing the automatic parking control (autoparks).

The autoparks include, for example, at least one of the following conditions: a condition that the engine 160 is stopped, a condition that no obstacles are present close to the vehicle 100 in the backward or forward direction, and a condition that the doors 110 of the vehicle 100 is closed.

If the determination in step S16 is affirmative, the process proceeds to step S18, and a light emission instruction signal is generated and transmitted from the vehicle-side communication unit 120 to the portable-side control unit 30.

The light emission instruction signal is a signal for instructing the light emission of the light source unit 60 constituting the portable device 10.

In the following step S20, it is determined whether or not a stop instruction signal transmitted from the portable device 10 has been received.

The stop instruction signal is a signal instructing to stop the transmission of the light emission instruction signal.

If an affirmative determination is made in step S20, the process proceeds to step S22, the generation of the light emission instruction signal is stopped, and the transmission of the light emission instruction signal is stopped.

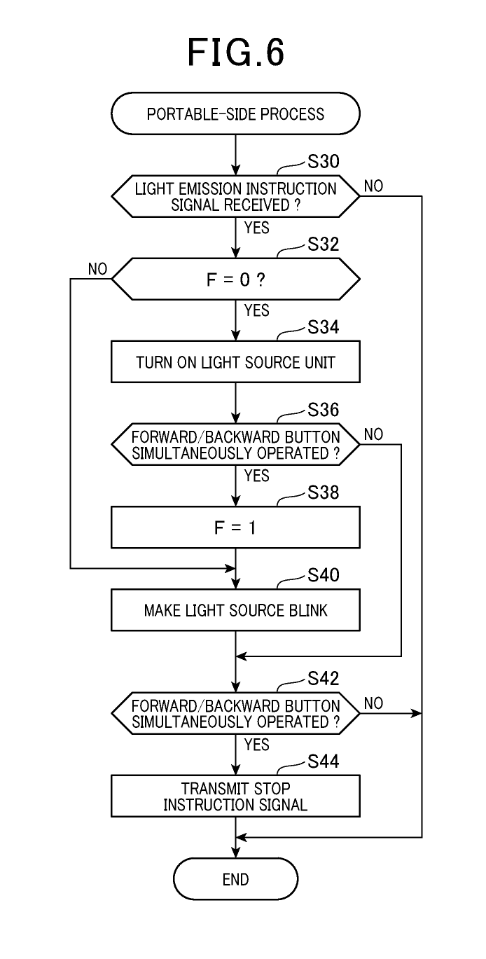

FIG. 6 shows a procedure of a process executed by the portable-side control unit 30.

This process is repeatedly executed at predetermined intervals, for example.

In this series of processing, first in step S30, it is determined whether or not the light emission instruction signal transmitted from the vehicle-side control unit 130 has been received.

If an affirmative determination is made in step S30, the process proceeds to step S32, and it is determined whether or not a value of the determination flag F is 0.

Note that the initial value of the determination flag F is set to 0.

If an affirmative determination is made in step S32, the process proceeds to step S34, and the light source unit 60 is turned on.

As a result, the forward arrow light emitting portion 22a and the backward arrow light emitting portion 23a sequentially emit light temporarily.

In the following step S36, it is determined whether or not both the forward button member 22 and the backward button member 23 have been pressed continuously for a predetermined time.

If an affirmative determination is made in step S36, the process proceeds to step S38, and the value of the determination flag F is set to 1.

If the process of step S38 is completed, or if a negative decision is made in step S32, the process proceeds to step S40, and the light source unit 60 is blinked.

Thereby, the forward arrow light emitting portion 22a and the backward arrow light emitting portion 23a intermittently emit light.

In the following step S42, it is determined whether or not both the forward button member 22 and the backward button member 23 have been pressed continuously for a predetermined time.

This process is a process for determining whether or not the automatic parking mode is instructed to shift to the normal mode.

If an affirmative determination is made in step S42, the process proceeds to step S44, and the stop instruction signal is generated and is transmitted from the portable-side communication unit 40.

According to the present embodiment described above, the operability of the portable device 10 is improved as described below.

The user stops the vehicle 100 in front of the parking space.

In the present embodiment as well, as in the first embodiment, the vehicle 100 is stopped directing the front portion thereof to the parking space.

After turning off the engine 160, the user has got out of the vehicle 100 holding the portable device 10 and closes the doors 110.

Thereafter, the vehicle-side control unit 130 makes affirmative determinations in steps S10, S12, S14, and S16 of FIG. 5.

Therefore, the light emission instruction signal is generated by the vehicle-side control unit 130, and the generated signal is transmitted from the vehicle-side communication unit 120.

The transmitted light emission instruction signal is received by the portable-side communication unit 40 and inputted to the portable-side control unit 30.

Therefore, the portable-side control unit 30 turns on the light source unit 60.

As a result, the forward arrow light emitting portion 22a and the backward arrow light emitting portion 23a emit light.

Therefore, the user can confirm where the forward and backward button members 22, 23 are located in the main body portion 11.

Thereafter, when the user presses both the forward and backward button members 22, 23, the portable-side control unit 30 blinks the light source unit 60.

Thereby, the forward arrow light emitting portion 22a and the backward arrow light emitting portion 23a intermittently emit light.

Here, a reason for switching the light emission modes of the light emitting portions 22a, 23a is to suppress the power of the power supply portion 50 from being consumed while indicating the positions of the button members by light emission.

That is, in the present embodiment, it is configured that the button members 22, 23 are continuously pressed when the vehicle 100 is moved forward or backward.

With this configuration, it is considered that the operability of the portable device 10 will not be impaired even if the user changes the light emission mode after the position of the button member that the user wishes to press is known and once the pressing operation is started.

Further, according to the configuration in which the light emission modes of the light emitting portions 22a, 23a are switched on, it is possible to notify the user that the operation mode of the vehicle 100 is switched to the automatic parking mode.

Therefore, the user can confirm that the automatic parking is being properly performed.

Thereafter, the vehicle 100 moves forward for a period during which the forward button member 22 is pressed by the user, and the vehicle 100 is parked in a predetermined position.

Thereafter, by the user continuously pressing both forward and backward button members 22, 23, the portable-side control unit 30 generates the stop instruction signal.

The generated stop instruction signal is inputted to the vehicle-side control unit 130 via the portable-side communication unit 40 and the vehicle-side communication unit 120.

As a result, the vehicle-side control unit 130 stops the generation of the light emission instruction signal and stops the engine 160.

According to the present embodiment described above, the light source unit 60 emits light when the user has got out of the vehicle and is present near the vehicle 100.

Therefore, the light emission of the light source section 60 can be kept to the minimum necessary, and power of the power supply section 50 can be suppressed from being consumed.

Further, in the present embodiment, even when the user has exited and is present near the vehicle 100, the light source unit 60 does not emit light when the autopark of the automatic parking control is not satisfied.

Therefore, the user can confirm that the current situation is a situation unsuitable for performing the automatic parking control.

Further, in the present embodiment, only parts of areas of the forward and backward button members 22, 23 are made to be the forward and backward arrow light emitting portions 22b, 23b.

Therefore, the area through which light is passing through can be reduced so that an illuminance of the light source section 60 can be reduced, and the number of the light source sections 60 can be reduced.

This makes it possible to suppress the power of the power supply unit 50 from being consumed as compared with a configuration in which entire areas of the forward and backward button members 22, 23 are the forward movement and backward arrow light emitting portions 22b and 23b.

As a result, it is possible to reduce the frequency of exchanging the power supply unit 50 and the like, thereby enhancing the user's convenience.

### Other Embodiments

It should be noted that each of the above embodiments may be modified as follows.

In the second embodiment shown in FIG. 6, the process of step S40 may be a process of making the light source unit 60 darker than the light source unit 60 in the process of step S34.

Even in this case, it is possible to suppress the power of the power supply unit 50 from being consumed while notifying the user that the operation mode of the vehicle 100 has switched to the automatic parking mode.

In the second embodiment, it is not necessary to change the light emission mode of the light source unit 60 until the portable-side control unit 30 outputs the stop instruction signal after receiving the light emission instruction signal.

In step S14 of FIG. 5 of the second embodiment, it may be determined whether or not the surroundings of the user are dark based on the current location, the date and time.

Even in this case, for example, if the user is in outdoors, it can be determined whether or not the surroundings of the vehicle 100 are dark.

In the second embodiment, all of the areas of the forward and backward button members 22, 23 may be made to be the forward and backward arrow light emitting portions 22b, 23b.

In FIG. 2, the shapes of the forward and backward arrow light emitting portions 22a, 23a may be the same and the shapes of the lock and unlock light emitting portions 20a, 21a may be the same.

In each of the above embodiments, the lock and unlock light emitting portions 20a, 21a may not be provided in the lock and unlock button members 20, 21.

In each of the above embodiments, the forward arrow light emitting portion and the backward arrow light emitting portion may be formed on portions other than the peripheral edge portions of the forward button member 22 and the backward button member 23.

Further, in each of the above-described embodiments, entire surface of the forward button member 22 and the backward button member 23 may be the forward arrow light emitting portion and the backward arrow light emitting portion.

A method of starting the light emission of the light source unit 60 is not limited to the one exemplified in the second embodiment, but may be the following method, for example.

Specifically, the portable device 10 includes an acceleration sensor that detects its own acceleration.

In this configuration, when the portable-side control unit 30 determines that an acceleration detected by the acceleration sensor exceeds a predetermined value, the portable-side control unit 30 may cause the light source unit 60 to emit light.

According to this method, as the user shakes the portable device 10, each of the light emitting portions 22a, 22b emits light.

Note that in order to reduce unnecessary operation of the light emission control, the light source section 60 may be caused to emit light when the portable control section 30 determines that the acceleration detected by the acceleration sensor exceeds a predetermined value for a plurality of times.

An operation member for instructing the generation of the move-forward instruction signal and the move-backward instruction signal is not limited to the button member, but may be a slide type operation member, for example.

In addition, it may be displayed in an icon form on a touch panel as an operation member, for example.

The main body portion 11 constituting the portable device 10 may have a shape which is not line symmetrical with respect to an axis.

A dedicated button member for instructing the generation of the automatic parking instruction signal may be provided in the main body portion 11.

A vehicle constituting the parking assistance system is not limited to one having only an engine as a driving power source, and may be provided with only a motor, or may be provided with both an engine and a motor.

What is claimed is:

1. A portable device which is applied to a vehicle having an automatic parking function of allowing the vehicle to run and park automatically in a predetermined position in a state where a user is out of the vehicle, and which is operated in a state of being carried by the user, the portable device comprising:
a first operating section which is operated by the user when moving the vehicle forward;
a second operating section which is operated by the user when moving the vehicle backward; and
a signal output unit that outputs a move-forward instruction signal for moving the vehicle forward in a period during which the first operating section is operated, and a move-backward instruction signal for moving the vehicle backward in a period during which the second operating section is operated; wherein,
each of the operating sections has a light emitting portion that emits light.

2. The portable device according to claim 1, wherein,
the signal output unit outputs an automatic parking instruction signal for setting the vehicle into an automatic parking mode by touch-operating both of the operating sections.

3. The portable device according to claim 1, wherein,
the portable device includes a light emission control unit for causing the light emitting portion to emit light on condition that the user has exited the vehicle and the user is present within a predetermined range from the vehicle.

4. The portable device according to claim 3, wherein,
the light emission control unit does not cause the light emitting portion to emit light when a autopark for performing an automatic parking of the vehicle is not satisfied.

5. The portable device according to claim 3, wherein,
when the user is performing the touch-operation of each of the operating sections, the light emission control unit causes the light emitting portion to emit light in a mode different from a case where the touch-operation is not performed.

6. The portable device according to claim 1, wherein,
the light emitting portion is made of a luminous material.

7. A portable device according to claim 1, wherein,
the light emitting portion is formed in a part of each of the operating sections.

8. The portable device according to claim 7, wherein,
the light emitting portion is formed along a peripheral edge portion of each of the operating sections.
